(19) United States
(12) Patent Application Publication
(10) Pub. No.: US 2026/0133086 A1
(43) Pub. Date: May 14, 2026

(54) PRESSURE MEASURING CELL HAVING EVALUATION ELECTRONICS AND 4-20 MA INTERFACE

(71) Applicant: VEGA Grieshaber KG, Wolfach (DE)

(72) Inventors: Martin Mellert, Steinach (DE); Bernhard Weller, Donaueschingen (DE); Jochen Huber, Wolfach (DE)

(21) Appl. No.: 18/704,591

(22) PCT Filed: Oct. 17, 2022
(86) PCT No.: PCT/EP2022/078839

§ 371 Date: Apr. 25, 2024

(30) Foreign Application Priority Data
Oct. 29, 2021 (DE) 10 2021 128 370.1

(51) Int. Cl. G01L 1/14; G01L 1/22

(52) U.S. Cl. CPC G01L 1/144; G01L 1/225; G01L 1/2281

(57) ABSTRACT

The invention relates to a pressure measuring cell having a pressure sensor and evaluation electronics which are integrated into the pressure measuring cell. In the disclosed embodiments, the pressure measuring cell has a 4-20 mA interface for supplying energy.

### FIELD OF THE INVENTION

The present invention relates to a pressure measuring cell having integrated evaluation electronics and a 4-20 mA interface for energy supply.

### BACKGROUND OF THE INVENTION

Pressure measuring cells are known from the prior art, which for example detect a pressure change due to deformation of a membrane and a change in a capacitance which results from it. Pressure measuring cells of this type are termed capacitive pressure measuring cells. Furthermore, resistive or piezoresistive pressure measuring cells exist, in which the deformation of a membrane is detected for example by means of strain gauges and the pressure is ascertained from a change in resistance of the strain gauges, and also piezoelectric pressure measuring cells which make use of the piezoelectric effect to determine pressure.

The differentiation of pressure measuring cells according to the materials oriented to the process, that is to say the materials that come into contact with the process environment and the process media, generally differs between metallic and ceramic pressure measuring cells, wherein one has a metallic membrane and the other has a ceramic membrane. For technical manufacturing and measurement reasons, a base body of the pressure measuring cell is frequently manufactured from the same material as the membrane. For technical manufacturing reasons, a connection between the same or similar materials is often easier to produce than a connection between different materials. For technical measurement reasons, it is advantageous to use materials with similar or ideally identical thermal coefficients of expansion-this also is easier to achieve for the same or similar materials.

Whether absolute or relative pressures can be measured generally depends on whether a second pressure, for example an external pressure, is supplied to the rear side of the membrane or whether the rear side of the membrane is evacuated.

The evaluation electronics for the sensor signal of the sensor of the pressure measuring cell are typically placed outside of the housing of the pressure measuring cell and contacted by means of through-plated holes that are led to the outside. This means that the signal path from the sensor to the evaluation electronics is relatively long, so the signal-to-noise ratio is not optimal. Too large a signal-to-noise ratio causes the sensor signal to become distorted and therefore less precise.

### SUMMARY OF THE INVENTION

Accordingly, the invention is based on the object of providing a pressure measuring cell which has an optimized measuring set-up and improves the incoming signal quality at the evaluation unit compared to the prior art.

It is to be noted that the features detailed individually in the claims can be combined with one another in any desired, technically sensible, manner (also beyond category boundaries, for example between method and device) and indicate further embodiments of the invention. The description additionally characterizes and specifies the invention in connection with the figures in particular.

It is further noted that a conjunction “and/or” used here, and being located between two features and linking the same to one another, is always to be understood to mean that in a first embodiment of the subject matter according to the invention, only the first feature may be present, in a second embodiment only the second feature may be present, and in a third embodiment both the first and the second feature may be present.

A pressure measuring cell according to one aspect of the invention having a pressure sensor and evaluation electronics which are integrated into the pressure measuring cell is characterized in that the pressure measuring cell exclusively has a 4-20 mA interface for supplying energy.

Evaluation electronics integrated into the pressure measuring cell is to be understood to mean that the evaluation electronics are part of the pressure measuring cell and can for example be positioned inside a housing of the pressure measuring cell. It is also conceivable that the evaluation electronics are positioned in an interior of the housing, in which the pressure sensor is also located. The evaluation electronics can however also be positioned on an outer side of the housing, as the signal paths can likewise be kept very short there. One further option is to position the evaluation electronics between two housing parts of the pressure measuring cell, such as for example between a base body and a closure element or between two parts of a separable closure element. It is characteristic for integrated evaluation electronics that the evaluation electronics belong to the pressure measuring cell and for example are not accommodated in a different housing which is arranged further away from the sensor. Due to the integration of the evaluation electronics in the pressure measuring cell, the signal processing takes place inside the pressure measuring cell and no longer, as is otherwise customary, in external electronic circuits.

The joining of the evaluation electronics to the pressure measuring cell or the housing thereof is preferably realized by an adhesive joint. However, other joining options, such as for example glass-solder, solder, welded or form-fit joints are also possible.

The evaluation electronics are in any case placed close to the sensor by positioning in or on the housing of the pressure measuring cell, which makes the signal paths between sensor chip and evaluation electronics very short. The signal paths are for example realized using bondwires, which means that the signal-to-noise ratio is improved and as a result, the signal quality is likewise improved. Due to the shorter signal paths, a faster or more direct reaction time is also achieved. Connection to the outside can for example take place with the aid of through-plated holes which are led through the housing of the pressure measuring cell. The evaluation electronics are in turn electrically connected to the pressure sensor by bondwires if the evaluation electronics are positioned directly in the measuring chamber.

One further advantage of integrated evaluation electronics is that the pressure measuring cell outputs the same signals representing the measured value independently of the measuring principle, such as e.g. resistive or capacitive, as the evaluation electronics has already processed the output signal of the pressure sensor and can output a measured value for the pressure.

The energy supply of the pressure measuring cell takes place via the 4 mA to 20 mA current signal via the two-wire cable, so that in addition to the two-wire cable no additional supply line is necessary. In order to keep the wiring and installation expense and the safety measures, for example in the case of use in explosion-protected areas, as small as possible, it is also not desirable to provide additional power supply cables.

The signal transmission of the measured value of the pressure measuring cell for example to a supervisory unit likewise takes place in accordance with the known 4 mA to 20 mA standard, in which a 4 mA to 20 mA current loop or a two-wire cable is formed between the pressure measuring cell and the supervisory unit. In addition to the analog transmission of signals, there is the possibility that the thus connected units transmit further information to the supervisory unit or receive further information from the same according to various other protocols, particularly digital protocols. The HART protocol or the Profibus PA protocol are examples of such protocols.

Advantageous configurations and variants of the invention emerge from the dependent claims and the following description. The features detailed individually in the dependent claims can be combined with one another in any desired, technically sensible manner and also with the features explained in more detail in the following description, and represent other advantageous design variants of the invention.

In one embodiment of the pressure measuring cell, the pressure measuring cell is characterized in that the evaluation electronics are incorporated within an ASIC (application-specific integrated circuit). This may be realized as a stand-alone module and applied to the displacer or integrated into the displacer. The ASIC is an energy-saving processor which, due to its low power consumption, makes it possible to operate the pressure measuring cell using a 4-20 mA energy supply. To this end, leakage currents are prevented and standby states of circuit components, such as the controller or the memory for example, are activated as frequently as possible.

The operating voltage of the ASIC is preferably limited to 2.1 V, further preferably to 1.6 V, further preferably to 1.2 V. The limitation of the operating voltage of the ASIC means that energy can be saved and the electrical losses are minimized. In order to achieve these specifications, a special 90 nm semiconductor production process is used to produce the ASIC, which makes it possible to operate the resulting circuits at lower voltages.

Preferably, the evaluation electronics are configured to galvanically isolate the pressure sensor from the electrical terminals of the pressure measuring cell. Electrical terminals of the pressure measuring cell means the electrical terminals which are led to the outer side of the pressure measuring cell.

In a further embodiment of the pressure measuring cell, the pressure measuring cell is characterized in that the evaluation electronics comprise a temperature sensor for detecting the temperature of the pressure measuring cell.

One advantage from the positioning of the evaluation electronics in the pressure measuring cell results from the thermal coupling to the same. Thus, temperature fluctuations can be detected at the pressure sensor, which lead to an expansion of the materials and therefore to a pressure change in the interior of the sensor. The evaluation electronics can thus undertake temperature compensation with the aid of the measured temperature and output a corrected measured value. In addition, conclusions can be drawn about the process parameters by means of the measured temperature and thus the process itself can also be optimized.

It is likewise conceivable that the evaluation electronics of the pressure measuring cell are set up in such a manner that the pressure measuring cell can be calibrated by the evaluation electronics. Due to the integrated evaluation electronics, the pressure measuring cell or the pressure sensor thereof can be investigated and possibly recalibrated by applying defined pressures and temperatures without further calibration devices.

A further embodiment of the pressure measuring cell is characterized in that the evaluation electronics are SIL 2 certified.

The SIL standard (safety integrity level standard) according to the safety standard EN 61508 defines four well differentiated levels for specifying the requirement for the safety integrity of safety functions which are assigned to the E/E/PE safety-relevant system, wherein the safety integrity level 4 represents the highest level of safety integrity and the safety integrity level 1 represents the lowest level.

A further embodiment of the pressure measuring cell is characterized in that the evaluation electronics have a measuring frequency of at least 1 Hz with a precision of at least 19 bits. Due to a low measuring frequency of 1 Hz and a low resolution of the measuring range, energy can be saved during the measurement.

Preferably, the evaluation electronics have a measuring frequency of at least 1 kHz with a precision of at least 12 bits. The higher the measuring frequency and the greater the precision, the more energy is required from the pressure measuring cell. With regards to the 4-20 mA energy supply, the evaluation electronics are therefore accordingly designed in an energy-saving manner, to allow measuring frequencies in the region of 1 kHz and precisions of 12 bits, without unnecessarily putting strain on the energy supply.

If a metallic pressure measuring cell is used, this has a base body and a metallic membrane that is arranged on the base body, wherein a membrane chamber is formed between the membrane and the base body, a pressure sensor that is arranged in a sensor chamber of the base body, wherein a connection duct is formed between the membrane chamber and the sensor chamber and the chambers are filled with a diaphragm seal medium for transmitting a pressure that is acting on the membrane. As the volume of the diaphragm seal medium should be kept as low as possible, it is characteristic for a pressure measuring cell of this type that a displacer sits in the sensor chamber. In an embodiment of the pressure measuring cell of this type, the pressure measuring cell is characterized in that the evaluation electronics are positioned on the displacer.

The evaluation electronics are arranged on the displacer. The joint between evaluation electronics and displacer is preferably configured as an adhesive joint. The adhesive joint is in this case preferably adapted to the mostly different thermal coefficients of expansion of the displacer and the evaluation electronics. Ideally, the adhesive layer compensates the differential lengths that occur in this case and can withstand the shear forces that occur, so that a secure fastening is ensured. Alternatively, the evaluation electronics can be applied directly on the displacer in the form of conducting tracks. A pressure measuring cell having a displacer that is functionalized in this manner occupies particularly little installation space.

The evaluation electronics can therefore be attached on the displacer in the vicinity of the sensor chip. Therefore, the evaluation electronics are placed close to the sensor, which makes the signal paths between sensor chip and evaluation electronics very short. The signal paths are for example realized using bondwires, so that the signal-to-noise ratio is improved and as a result, the signal quality is likewise improved. Due to the shorter signal paths, a faster or more direct reaction time is also achieved. Connection to the outside can for example take place with the aid of contacts which are led through the displacer and the closure element and which are in turn electrically connected to the evaluation electronics by means of bondwires on the upper side of the displacer.

The pressure measuring cell can be set up to operate according to a capacitive or a resistive measuring principle.

A capacitive pressure measuring cell has two electrodes which together form an electrical capacitor. The one electrode is arranged on a membrane in this case. Due to a pressure change that acts on the membrane, a distance between the electrodes is changed, so that a capacitance of the capacitor changes. The capacitance of the capacitor can be detected by the evaluation electronics and a pressure can be derived from that.

In a resistive pressure measuring cell, strain gauges are for example used on a membrane, which change their resistance when a pressure that is acting on the membrane deforms the membrane. Piezoresistive pressure sensors can also be used, which likewise correspondingly change their resistance owing to the deformation due to of pressure.

Due to the arrangement of the evaluation electronics in the pressure measuring cell, it is exposed to the temperature of the process, depending on the use case. Therefore, the pressure measuring cell is set up in one embodiment for an operating temperature of up to 150° C.

Preferably, the pressure measuring cell is set up for an operating temperature of up to 200° C.

Electronic circuits often react sensitively to high temperatures. Therefore, the pressure measuring cell with its evaluation electronics is built such that the same can still operate correctly at operating temperatures of 150° C. or 200° C., as for example, the temperature that acts directly on the evaluation electronics can be compensated so that a corrected, correct measured value can be output.

In a further embodiment, the pressure measuring cell is a pressure measuring cell for measuring an absolute pressure. That is to say, the pressure measurement takes place with respect to a vacuum as reference level.

Alternatively, this may be a pressure measuring cell which is designed for measuring a relative pressure. In this case, not only the side of the membrane facing the process, but also the underside of the membrane of the pressure sensor can be loaded with pressure. For example, the underside of the membrane can be exposed to the ambient pressure and therefore measure the pressure relatively to the ambient pressure. In this case, the pressure measuring cell may have a closure element having a through opening for pressure compensation, so that the rear side of the membrane can be loaded with a certain pressure.

A method according to the invention for producing a pressure measuring cell having evaluation electronics which are integrated into the pressure measuring cell is characterized in that the pressure measuring cell is supplied with energy by a 4-20 mA interface.

Further practical embodiments are described in the following in connection with the figures. In the figures:

### BRIEF DESCRIPTION OF THE DRAWINGS

FIG. 1 shows a metallic pressure measuring cell having integrated evaluation electronics on a displacer and a two-wire energy supply according to the 4-20 mA standard,

FIG. 2 shows a metallic pressure measuring cell having integrated evaluation electronics in a closure element of the pressure measuring cell,

FIG. 3 shows a metallic pressure measuring cell having integrated evaluation electronics on an outer side of the pressure measuring cell,

FIG. 4 shows a metallic pressure measuring cell having integrated evaluation electronics in a recess of a base body of the pressure measuring cell.

### DETAILED DESCRIPTION OF THE DRAWINGS

In the figures—insofar as nothing different is specified-the same reference symbols label the same components or components that correspond to one another with the same function.

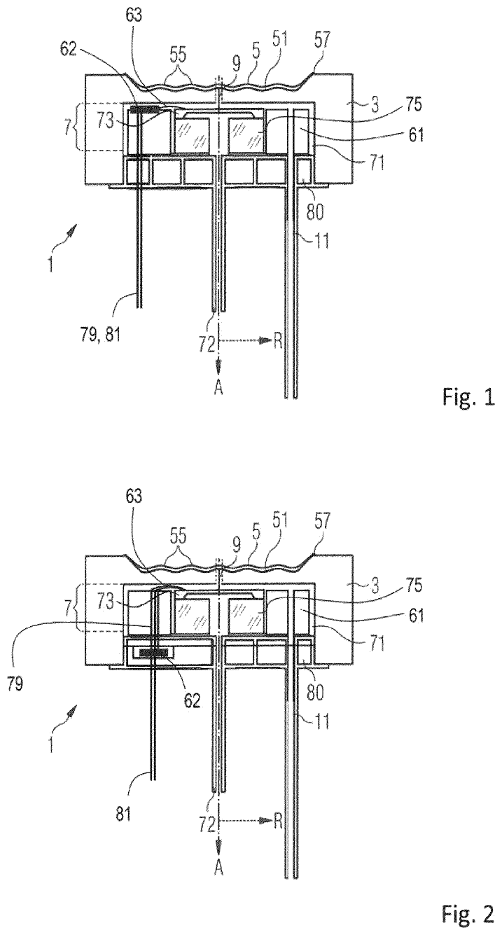

FIG. 1 shows an exemplary embodiment of a pressure measuring cell 1 according to the present application in a cross section with integrated evaluation electronics 62 and two-wire energy supply. The pressure measuring cell 1 shown is a metallic pressure measuring cell 1 for measuring a relative pressure, as the design has an opening for pressure compensation 72.

The pressure measuring cell 1 has essentially one metallic base body 3, a metallic membrane 5 that is arranged on the front side on the base body 3 in axial direction A, and a pressure sensor 7 that is arranged in a sensor chamber 71 that is formed in the base body 3.

The sensor chamber 71 is in fluid communication, via a communication channel 9, with a membrane chamber 51 that is arranged between the base body 3 and the membrane 5.

The sensor chamber 71 is closed in the rear-side direction by a closure element 80, wherein the closure element 80 has through-plated holes 79 for the 4-20 mA energy supply. The evaluation electronics 62 are contacted to the outside through the through-plated holes 79.

The pressure sensor 7 is arranged in the sensor chamber 71. The pressure sensor 7 has a sensor chip 73 as pressure-sensitive element, which is arranged on the closure element 80 by means of a sensor carrier 75. The sensor chip 73 is connected to the evaluation electronics 62 by electrical connections 63 that are realized as bondwires.

A rear-side part of a membrane of the sensor chip 73 can be loaded either with an ambient pressure or a reference pressure via a line for pressure compensation 72, which is likewise led through the closure element 80 to the rear side of the sensor chip 73. The reference pressure can also be a vacuum, so that absolute pressure measurement can be carried out.

In the exemplary embodiment illustrated in FIG. 1, the closure element 80 further has a filling opening 11 with a pipe section arranged thereon, by means of which filling opening the sensor chamber 71, the communication channel 9 and the membrane chamber 51 can be filled with a diaphragm seal medium 13, for example a synthetic oil. In the illustration of FIG. 1, this diaphragm seal medium 13 is not yet inserted however for the sake of better clarity.

The membrane 5 is in the present exemplary embodiment joined to the base body 3 by means of a circumferential joint 57, a weld in the present case. The membrane 5 in the present cross-sectional illustration has a wave-like surface contour which is designed in a manner corresponding to a surface contour of a wall of the base body 3 facing the membrane 5. This wave-like surface contour 55 means that the membrane 5 is flexible in the axial direction A, whereas a greatest possible rigidity is achieved in the radial direction R.

The surface contour 55 of the membrane 5 is transmitted from the base body 3 to the membrane 5 during the manufacturing of the pressure measuring cell 1. For this, the membrane 5 is loaded with an overpressure from the front after it has been fastened on the base body 3, so that it moulds to the membrane bed formed by the base body 3.

The displacer 61 is arranged inside the sensor chamber 71 and occupies a substantial part of the sensor chamber 71 which would otherwise be filled with diaphragm seal medium 13. In this manner, only a small volume is left over, predominantly flat areas, which are filled with diaphragm seal medium 13. The displacer 61 is substantially rotationally symmetrical in this exemplary embodiment, but may however deviate from rotational symmetry for example due to recesses for filling the sensor chamber 71 through the filling opening 11.

The evaluation electronics 62 are arranged on the displacer 61. The evaluation electronics can be attached on the surface by an adhesive joint. The evaluation electronics 62 are positioned in the direct vicinity of the sensor chip 73 and connected to the same by bondwires 63. The bondwires 63 are very short compared to a connection that is led to the outside, such as for example the through-plated holes 79, and therefore particularly advantageous for the quality of the signal of the sensor chip, as the signal-to-noise ratio is lower. In addition, the evaluation electronics 62 here comprise a temperature chip which detects the actual temperature of the diaphragm seal medium 13 and thus makes a temperature correction of the output pressure measurement signal possible.

The energy supply of the pressure measuring cell 1 or the evaluation electronics 62 takes place by means of the 4 mA to 20 mA current signal via a two-wire cable 81, so that in addition to the two-wire cable 81 no additional supply line is necessary. The signal transmission of the measured value of the pressure measuring cell 1 to a superordinate unit is at the same time realized by means of this two-wire cable 81. The pressure measuring cell 1 and the superordinate unit are connected by the two-wire cable 81.

FIG. 2 shows a metallic pressure measuring cell 1 similarly to FIG. 1, but with integrated evaluation electronics 62 in a closure element 80 of the pressure measuring cell 1. The closure element 80 is designed in two pieces to this end and provides a cavity for accommodating the evaluation electronics 62.

The evaluation electronics 62 are electrically connected with the aid of through-plated holes 79. The contacting of the sensor chip 73 takes place by means of bondwires 63 which are connected to the through-plated holes 79 on the upper side of the displacer 61. The evaluation electronics 62 are contacted to the outside by the two-wire energy supply. The evaluation electronics 62 are connected via the two-wire cable 81 as in FIG. 1.

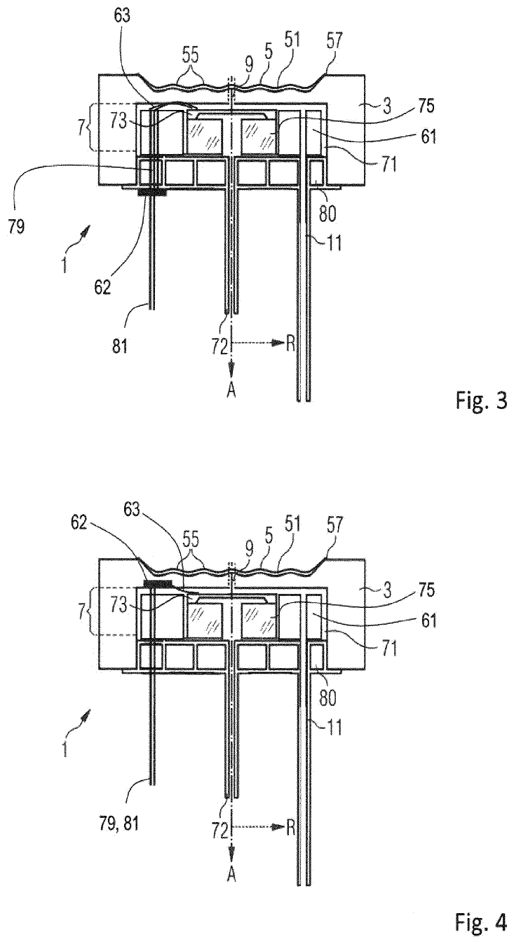

FIG. 3 shows a metallic pressure measuring cell 1 similarly to FIG. 1, but with integrated evaluation electronics 62 is accommodated on an outer side of the pressure measuring cell 1. The evaluation electronics 62 are placed onto the closure element 80 from outside and electrically connected to the sensor chip 73 there with the aid of through-plated holes 79 and bondwires 63. The evaluation electronics 62 themselves are supplied with energy by a two-wire cable 81.

FIG. 4 shows a metallic pressure measuring cell 1 similarly to FIG. 1, but with integrated evaluation electronics 62 in a recess of a base body 3 of the pressure measuring cell 1. The recess is accommodated in the base body 3 of the pressure sensor 1, so the evaluation electronics 62 can be fixed therein by means of an adhesive joint.

The two-wire energy supply is connected to the evaluation electronics 62 with the aid of the through-plated holes 79 or the two-wire cable 81. The evaluation electronics 62 are in turn connected to the sensor chip 73 using bondwires 63.

### REFERENCE LIST

1 Pressure measuring cell
3 Base body
5 Membrane
7 Pressure sensor
9 Communication channel
11 Filling opening
13 Diaphragm seal medium
51 Membrane chamber
55 Surface contour
57 Joint
61 Displacer
62 Evaluation electronics
63 Bondwires
71 Sensor chamber
72 Pressure compensation
73 Sensor chip
75 Sensor carrier
79 Through-plated holes
80 Closure element
81 Two-wire cable
A Axial direction
R Radial direction

1. A pressure measuring cell having a pressure sensor and evaluation electronics which are integrated into the pressure measuring cell, wherein
the evaluation electronics of the pressure measuring cell exclusively use 4-20 mA interface for supplying energy.

2. The pressure measuring cell according to claim 1, wherein
the evaluation electronics comprise an application specific integrated circuit (ASIC).

3. The pressure measuring cell according to claim 1, wherein
the pressure measuring cell comprises a diaphragm and a diaphragm seal medium adjacent the diaphragm, and
the evaluation electronics comprise a temperature sensor detecting a temperature of the diaphragm seal medium.

4. The pressure measuring cell according to claim 1, wherein
the evaluation electronics implement a calibration function through which the pressure measuring cell can be calibrated by the evaluation electronics.

5. The pressure measuring cell according to claim 1, wherein
the evaluation electronics are SIL 2 certified.

6. The pressure measuring cell according to claim 1, wherein
the evaluation electronics have a measuring frequency of at least 1 Hz with a precision of at least 12 bits.

7. The pressure measuring cell according to claim 1, wherein
a displacer is arranged in the pressure measuring cell, and
the evaluation electronics are positioned on the displacer.

8. The pressure measuring cell according to claim 1, wherein
the pressure measuring cell operates according to one or more of a capacitive or a resistive measuring principle.

9. The pressure measuring cell according to claim 1, wherein
the pressure measuring cell is functional at an operating temperature of up to 150° C.

10. The pressure measuring cell according to claim 1, wherein
the pressure measuring cell is a pressure measuring cell for measuring an absolute pressure.

11. The pressure measuring cell according to claim 1, wherein
the pressure measuring cell is a pressure measuring cell for measuring a relative pressure.

12. A method for producing a pressure measuring cell having a membrane and a pressure sensor, the pressure measuring cell being filled with a diaphragm seal medium for transmitting a pressure that is acting on the membrane to the pressure sensor, and evaluation electronics which are integrated into the pressure measuring cell, wherein
the pressure measuring cell is supplied with energy solely by a 4-20 mA interface.
